(19) United States
(12) Patent Application Publication
(10) Pub. No.: US 2013/0168123 A1
(43) Pub. Date: Jul. 4, 2013

(54) JUNCTION BOX FOR SOLAR CELL MODULE

(71) Applicant: Weihui WANG, Cixi (CN)

(72) Inventor: Weihui WANG, Cixi (CN)

(21) Appl. No.: 13/442,893

(22) Filed: Apr. 10, 2012

(30) Foreign Application Priority Data
Dec. 29, 2011 (CN) 201120561765.4

(51) Int. Cl. H02G 3/18

(52) U.S. Cl. 174/60

(57) ABSTRACT

A junction box used for a solar cell module including: a shell and an upper cover which can be matched, a T-shaped ring, a hollow petal basket, a nut, and a terminal riveted at the end of a cable. A conductive component and a diode are installed in the shell. A small end of the T-shaped ring is sleeved in the petal basket. The petal basket is sleeved in the nut. A connector matched with the nut is formed on the shell. A big end of the T-shaped ring is hermetically pressed at the connector and fixed via the nut. The terminal penetrates the T-shaped ring, the petal basket, and the nut to be connected with the conductive component in the shell.

### CROSS-REFERENCE TO RELATED APPLICATIONS

Pursuant to 35 U.S.C. §119 and the Paris Convention Treaty, this application claims the benefit of Chinese Patent Application No. 201120561765.4 filed Dec. 29, 2011, the contents of which, including any intervening amendments thereto, are incorporated herein by reference.

### CORRESPONDENCE ADDRESS

Inquiries from the public to applicants or assignees concerning this document should be directed to: MATTHIAS SCHOLL P.C., ATTN.: DR. MATTHIAS SCHOLL ESQ., 14781 MEMORIAL DRIVE, SUITE 1319, HOUSTON, Tex. 77079.

### BACKGROUND OF THE INVENTION

1. Field of the Invention

The invention relates to a solar energy conversion technology, and more particularly to a junction box used for a solar cell module.

2. Description of the Related Art

There are two problems with the connection between a junction box used for a solar cell module and a cable in the prior art: 1. The conductivity in connection between a conductive component inside the junction box and an external cable cannot be maintained for a long term, and its main reason is that the external cable often moves or swings to lead to form a worn contact point between the cable and the conductive component; 2. Due to the swing of the cable, the tightness at the joint between the junction box and the cable is difficult to keep long, and the components inside the junction box are vulnerable to damp heat, wet cold, thermal cycle, etc., and thus cannot work normally.

### SUMMARY OF THE INVENTION

In view of the above-described problems, it is one objective of the invention to provide a junction box used for a solar cell module that has a stable and tight connection with an external cable.

To achieve the above objective, in accordance with one embodiment of the invention, there is provided a junction box used for a solar cell module comprising: a shell and an upper cover which can be matched, a T-shaped ring, a hollow petal basket, a nut, and a terminal riveted at the end of a cable, wherein a conductive component and a diode are installed in the shell; a small end of the T-shaped ring is sleeved in the petal basket; the petal basket is sleeved in the nut; an connector matched with the nut is formed on the shell; a big end of the T-shaped ring is hermetically pressed at the connector and fixed via the nut; the terminal penetrates the T-shaped ring, the petal basket and the nut to be connected with the conductive component in the shell.

In a class of this embodiment, the end surface of the petal basket facing the shell is a wavy curved surface, a wavy curved surface mutually occluded with the end surface is arranged at the connector, one end of the petal basket far from the shell is claw-shaped, and the inner wall of the nut takes the shape of an arc gradually contracted towards the central axis of the nut; after the terminal is spliced on the conductive component, the nut is screwed, the claw-shaped end of the petal basket is gradually contracted inwards to extrude the T-shaped ring, and the cable is fastened under the action of the T-shaped ring, so that not only the sealing effect is achieved, but also no poor contact phenomenon occurs in the connection between the terminal and the conductive component due to the swing of the external cable under the condition without damaging the cable; after the end surface of the wavy curved surface is mutually occluded with the connector, the petal basket can be prevented from being worn along with the rotation during the process of screwing the nut.

In a class of this embodiment, the claw shape of the petal basket comprises at least three claw strips, a projecting part fitted with the arc-shaped inner wall of the nut is arranged at the end of each claw strip. The petal basket simplifies the structure and reduces the manufacturing cost when meeting the function of clamping the T-shaped ring.

In a class of this embodiment, a sealing ring is arranged at the position where the shell and the upper cover are covered with each other, so as to ensure the tightness of the whole junction box.

In a class of this embodiment, the conductive component is fixed in the shell through an upper shield, so as to prevent the conductive component from being loosened to cause poor contact and influence to the tightness, and the conductive component is conveniently disassembled and replaced.

Advantages of the invention are summarized below: the T-shaped ring is hermetically pressed at the connector under the matching action of the nut and the petal basket, and closely pressed with the cable, so that the tightness at the joint between the shell and the cable is effectively ensured, and the good waterproof, dampproof, and dustproof effects are achieved; the nut and the petal basket are fixed for the cable, the relative position of the terminal and the conductive component is very firm, and the contact between the terminal and the conductive component is not affected due to the swing of the external cable, so that the good connection stability is ensured; in addition, the junction box used for the solar cell module has the advantages of simple structure, simple and convenient installation operation, lasting and stable effect and no damage to both the component and cable.

### BRIEF DESCRIPTION OF THE DRAWINGS

FIG. 1 is a structural diagram of an upper cover of an junction box used for a solar cell module according to one embodiment of the invention;

FIG. 2 is a structural diagram of a sealing ring of an junction box used for a solar cell module according to one embodiment of the invention;

FIG. 3 is an exploded view of a shell of an junction box used for a solar cell module according to one embodiment of the invention;

FIG. 4 is an exploded view of a connected upper shield, conductive component, and terminal of an junction box used for a solar cell module according to one embodiment of the invention;

FIG. 5 is a structural diagram of a petal basket in FIG. 1 according to one embodiment of the invention; and

FIG. 6 is a diagram for a connection status of a junction box used for a solar cell module according to one embodiment of the invention.

### DETAILED DESCRIPTION OF THE EMBODIMENTS

For further illustrating the invention, experiments detailing a junction box used for a solar cell module are described below. It should be noted that the following examples are intended to describe and not to limit the invention.

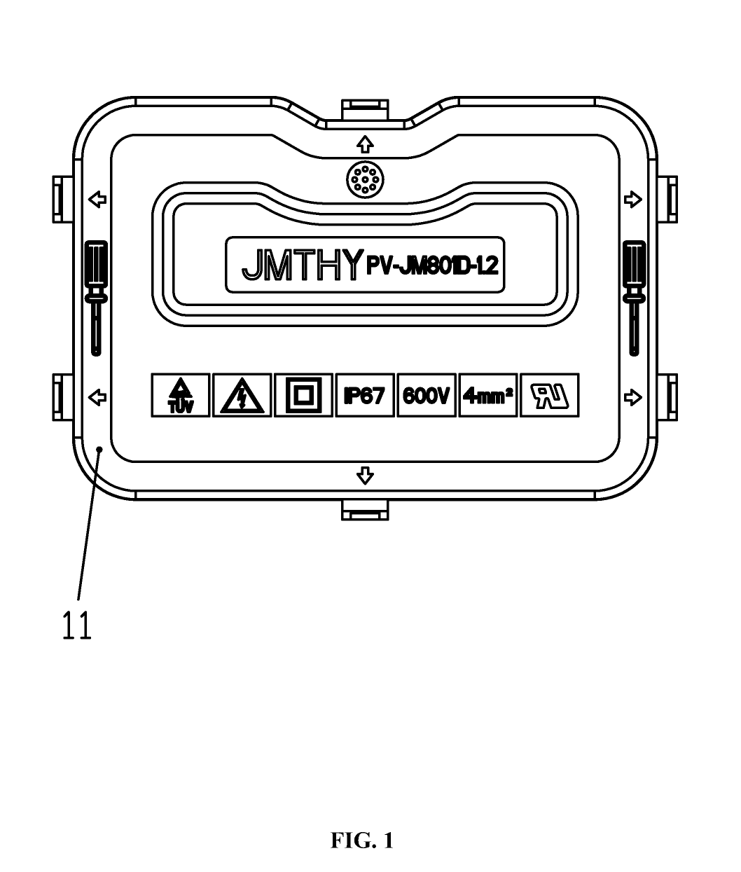

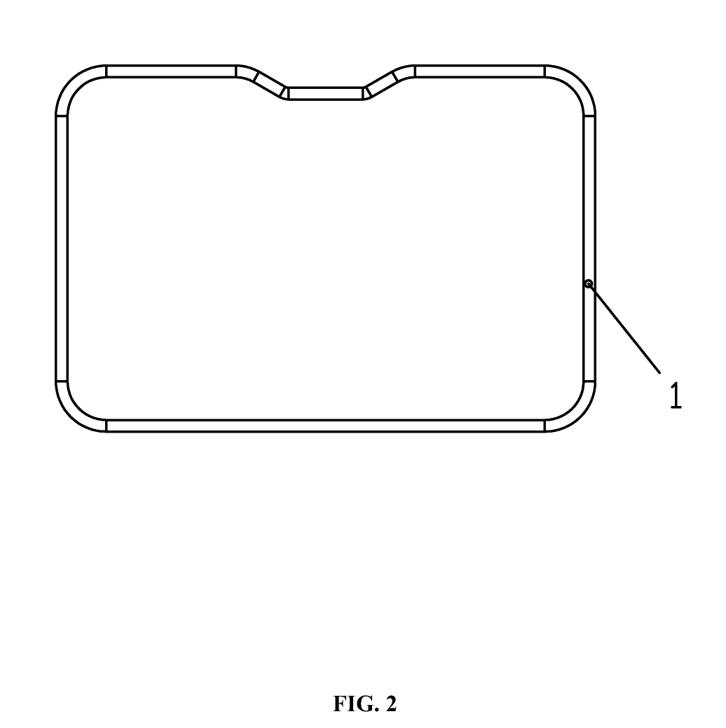

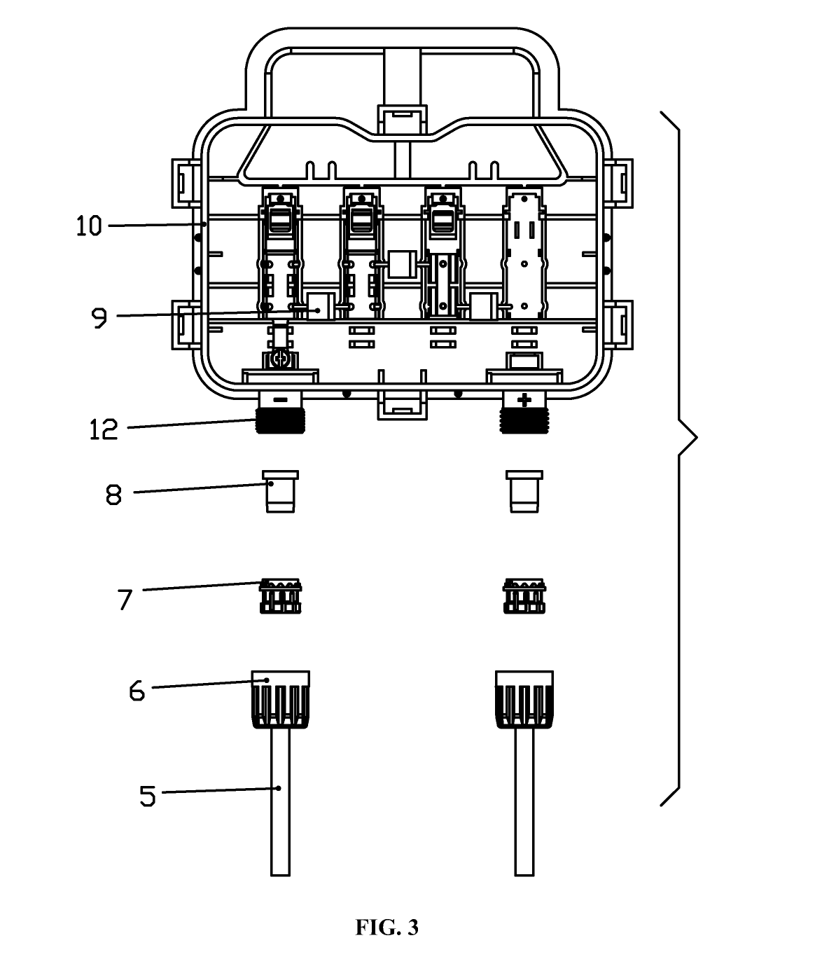

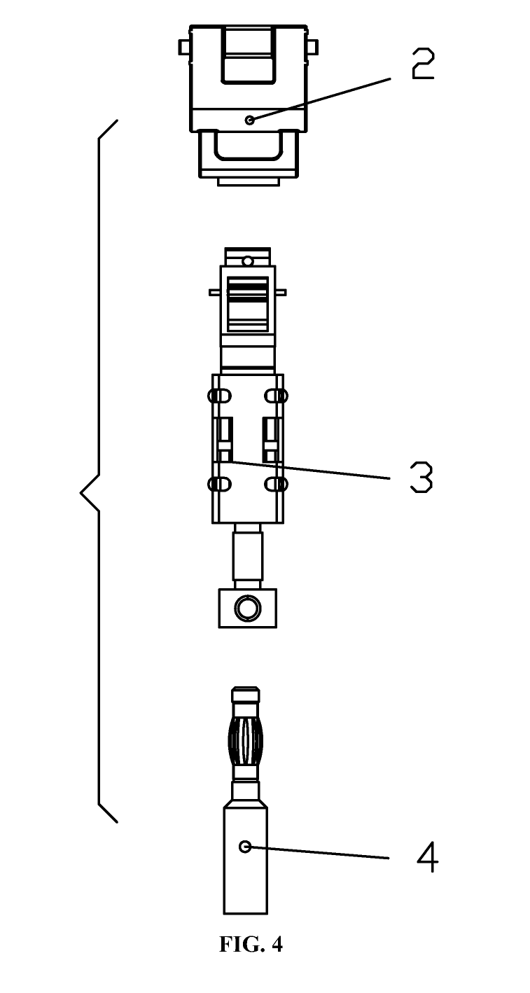

As shown in FIGS. 1-4, a junction box used for a solar cell module comprises a shell 10 and an upper cover 11 which can be matched. A conductive component 3 and a diode 9 are installed in the shell 10. The junction box used for the solar cell module further comprises a T-shaped ring 8, a hollow petal basket 7, a nut 6, and a terminal 4 riveted at the end of a cable 5. A small end of the T-shaped ring 8 is sleeved in the petal basket 7; the petal basket 7 is sleeved in the nut 6. A connector 12 matched with the nut 6 is formed on the shell 10; a big end of the T-shaped ring 8 is hermetically pressed at the connector 12 and fixed via the nut 6. The terminal 4 penetrates the T-shaped ring 8, the petal basket 7, and the nut 6 to be connected with the conductive component 3 in the shell 10.

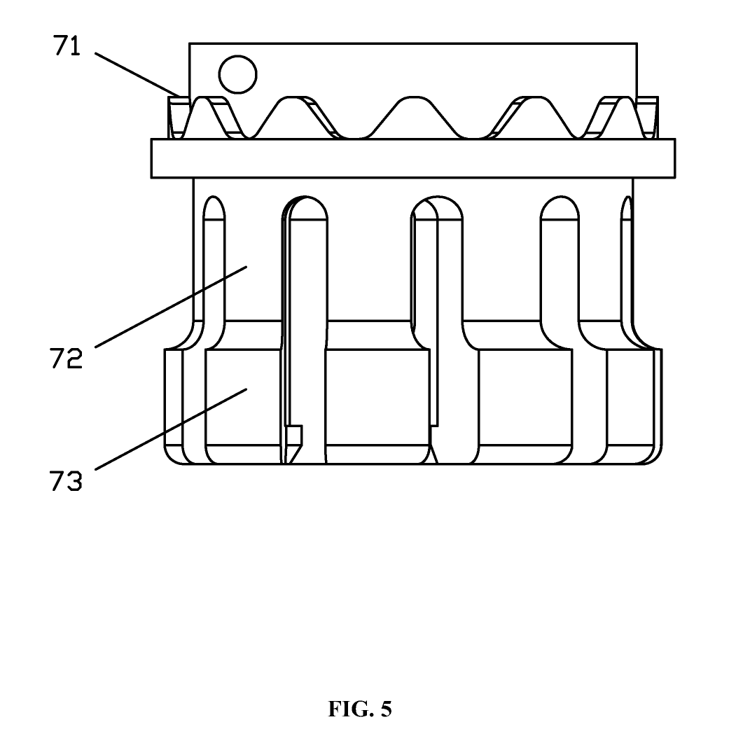

As shown in FIG. 5, the end surface 71 of the petal basket 7 facing the shell 10 is a wavy curved surface. A wavy curved surface mutually occluded with the end surface 71 is arranged at the connector 12, one end of the petal basket 7 far from the shell 10 is claw-shaped, and the inner wall of the nut 6 takes the shape of an arc gradually contracted towards the central axis of the nut 6; after the terminal 4 is spliced on the conductive component 3, the nut 6 is screwed, the claw-shaped end of the petal basket 7 is gradually contracted inwards to extrude the T-shaped ring 8, and the cable 5 is fastened under the action of the T-shaped ring 8, so that not only the sealing effect is achieved, but also no poor contact phenomenon occurs in the connection between the terminal 4 and the conductive component 3 due to the swing of the external cable 5 under the condition without damaging the cable 5; after the end surface 71 of the wavy curved surface is mutually occluded with the connector 12, the petal basket 7 can be prevented from being worn along with the rotation during the process of screwing the nut 6.

The claw shape of the petal basket 7 comprises eight claw strips 72. A projecting part 73 fitted with the arc-shaped inner wall of the nut 6 is arranged at the end of each claw strip 72, and the petal basket 7 simplifies the structure and reduces the manufacturing cost when meeting the function of clamping the T-shaped ring 8.

A sealing ring 1 is arranged at the position where the shell 10 and the upper cover 11 are covered with each other, so as to ensure the tightness of the whole junction box.

The conductive component 3 is fixed in the shell 10 through an upper shield 2, so as to prevent the conductive component 3 from being loosened to cause poor contact and influence to the tightness, and the conductive component 3 is conveniently disassembled and replaced.

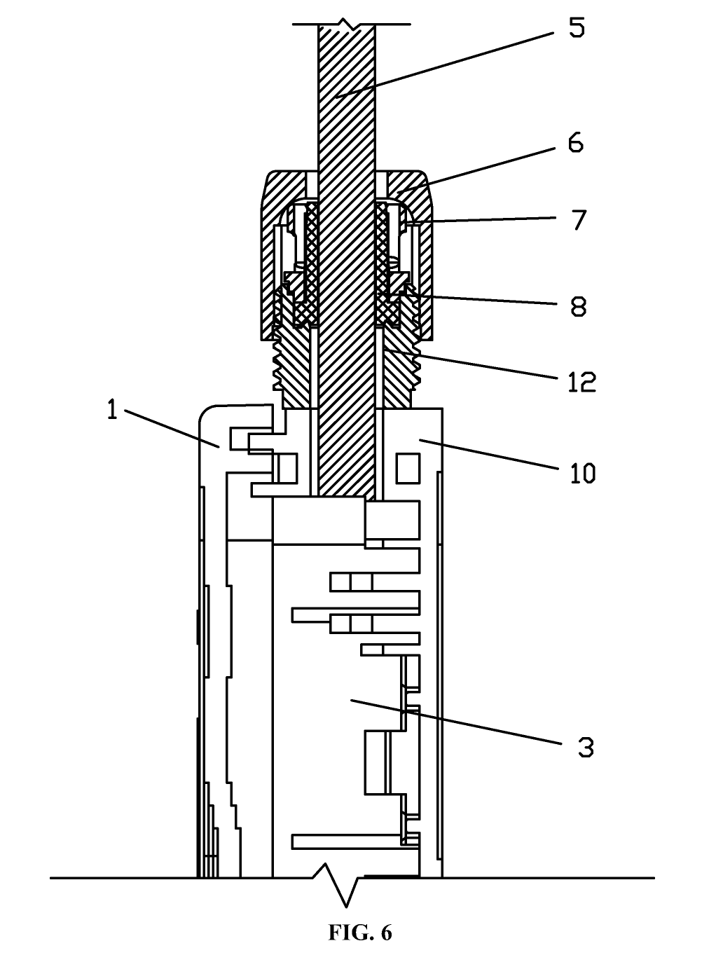

As shown in FIG. 6, a diagram for the connection status of the junction box used for a solar cell module shows that the T-shaped ring 8 is hermetically pressed at the connector 12 under the matching action of the nut 6 and the petal basket 7, and closely pressed with the cable 5, so that the tightness at the joint between the shell 10 and the cable 5 is effectively ensured, and the good waterproof, dampproof and dustproof effects are achieved; the nut 6 and the petal basket 7 are fixed for the cable 5, the relative position of the terminal 4 and the conductive component 3 is very firm, and the contact between the terminal 4 and the conductive component 3 is not affected due to the swing of the external cable, so that the good connection stability is ensured.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A junction box used for a solar cell module, comprising:
a) a shell and an upper cover which can be matched;
b) a T-shaped ring;
c) a hollow petal basket;
d) a nut; and
e) a terminal riveted at the end of a cable;
wherein
a conductive component and a diode are installed in the shell;
a small end of the T-shaped ring is sleeved in the petal basket;
the petal basket is sleeved in the nut;
a connector matched with the nut is formed on the shell;
a big end of the T-shaped ring is hermetically pressed at the connector and fixed via the nut; and
the terminal penetrates the T-shaped ring, the petal basket, and the nut to be connected with the conductive component in the shell.

2. The junction box of claim 1, wherein
an end surface of the petal basket facing the shell is a wavy curved surface;
a wavy curved surface mutually occluded with the end surface is arranged at the connector;
one end of the petal basket far from the shell is claw-shaped; and
the inner wall of the nut takes the shape of an arc gradually contracted towards the central axis of the nut.

3. The junction box of claim 2, wherein the claw shape of the petal basket comprises at least three claw strips, and a projecting part fitted with the arc-shaped inner wall of the nut is arranged at the end of each claw strip.

4. The junction box of claim 1, wherein a sealing ring is arranged at the position where the shell and the upper cover are covered with each other.

5. The junction box of claim 1, wherein the conductive component is fixed in the shell through an upper shield.
